(19) United States
(12) Patent Application Publication
(10) Pub. No.: US 2003/0026363 A1
(43) Pub. Date: Feb. 6, 2003

(54) Adaptive automatic gain control

(76) Inventors: Jan Stoter, Hengelo (NL); Arnoud van der Wal, Hengelo (NL); Johan van de Hee, Enschede (NL)

Correspondence Address: NIXON & VANDERHYE P.C., 8th Floor, 1100 North Glebe Road, Arlington, VA, 22201, US

(21) Appl. No.: 09/917,771

(22) Filed: Jul. 31, 2001

(51) Int. Cl. H04L 27/08

(52) U.S. Cl. 375/345

(57) ABSTRACT

An adaptive automatic gain control loop in a radio receiver includes an amplifier with an adjustable gain to variably increase or decrease the signal level of the received signal. Plural data blocks are received, with each data block potentially having a different signal level when received. Before or at the very beginning when substantive data in a data block are processed in the amplifier, the gain of that amplifier is rapidly adjusted or preset to a predetermined signal level for that data block. By adapting the gain of the amplifier before or just as the data in the block are processed by the amplifier to an appropriate level, the received signal can be adjusted to a desired dynamic range. For example, by adapting the received signal level to the dynamic range of an analog-to-digital converter of a receiver, e.g., a UTRA/TDD or TD-SCDMA receiver, the bit error rate at the start of the data block is decreased.

### FIELD OF THE INVENTION

The present invention relates to automatic gain control (AGC), and more particularly, to providing adaptive AGC to accommodate rapid changes in the power level of received signals.

### BACKGROUND AND SUMMARY OF THE INVENTION

Modern radio receivers use electronic control devices to accommodate less expensive components with a limited dynamic range. The dynamic range of such an electronic device or component is the range over which it can produce a suitable output signal in response to an input signal. It is often defined as the difference in decibels (dB) between the noise level of the system and the level at which the output is saturated. If the signal level of a received signal exceeds the dynamic range of a receiver component, it saturates that component introducing distortion errors. One of those components is an analog-to-digital converter. These control devices influence the input gain of the received signal such that it fits within the limited dynamic range of the receiver. On the other hand, a larger dynamic range is beneficial in achieving better resolution, and therefore accuracy, at the analog-to-digital converter.

In a Time Discrete Multiple Access, TDMA system, the level of the radio input signal differs in received strength from time slot-to-time slot. For each time slot allocated to a user, the strength of a received signal changes in response to variations in propagation conditions, e.g., signal path variations resulting from movement from a mobile radio unit. Propagation conditions that adversely affect signal strength include physical obstructions in the propagation paths of the signals, constructive and destructive interference of multiple signals caused by signal reflections from buildings and other objects, and varying distance between mobile radio units and base stations.

In modern receivers, an automatic gain control (AGC) control loop is provided in the receiver to control the input signal power level so that it is calibrated to the dynamic range of one or more of the components of the receiver, e.g., the analog-to-digital converter or the digital receiver. If the signal level of the input signal is too high or the current gain setting is too high for that signal level, the AGC reduces the gain of an adjustable gain amplifier so that the corresponding signal output from the amplifier fits within the target dynamic range. Conversely, if the signal received signal level is too low, the AGC increases the gain of the adjustable amplifier to bring the low level input signal into the target dynamic range.

In systems where the receiver receives a continuous signal, a relatively simple automatic gain control loop is adequate to control the gain of the receiver so that the signal uses the available receiver dynamic range optimally. However, there are certain situations and/or systems in which the receiver does not receive a continuous signal or the signal level varies dramatically in short periods of time. One such situation occurs when a mobile radio initially is activated and searches for a synchronization signal from one or more base stations associated with a mobile radio network. In some third generation cellular radio systems, the synchronization channel is only transmitted once or twice per frame. In addition to this, the data is transmitted without a preamble that could be used to adjust the AGC loop. In all of these circumstances, the receiver lacks an accurate starting point from which to start the automatic gain control. Essentially, the automatic gain control starts from “zero” and must “catch-up” to the power level of the received synchronization signal. During this delay or lag time while the AGC catches up with the power level of the received signal, the AGC is not properly calibrated, which creates errors in demodulating the data. It may even result in delayed synchronization if the data is missed or otherwise lost in error or noise.

A similar problem is confronted in time division multiplexed types of radio communication systems. One example is a time division duplex (IDD) type of cellular system where information is transmitted in time slots separated by guard spaces during which no information is transmitted. Such a TDD system is particularly challenging for an automatic gain controller because it must adapt from the guard space power level of essentially the noise floor or “0” up to an unknown signal level of the next received time slot. Moreover, the power level of the data in two consecutive time slots may vary dramatically. Consequently, the AGC lags behind the received signal level so that the gain is not properly calibrated, with the result of clipping (signal too high), or poor resolution (signal too low). Improper calibration results in errors.

The present invention provides an adaptive automatic gain controller that overcomes the problems noted above. A radio receiver includes an amplifier with an adjustable gain to variably increase or decrease the signal level of the received signal. Plural data blocks are received, with each data block potentially having a different signal level when received. Before or at the very beginning when substantive data in a data block are processed in the amplifier, the gain of that amplifier is rapidly adjusted or preset to a predetermined signal level for that data block. By adapting the gain of the amplifier before or just as the data in the block are processed by the amplifier to an appropriate level, the received signal can be adjusted to a desired dynamic range. For example, by adapting the received signal level to the dynamic range of an analog-to-digital converter of the receiver, the bit error rate at the start of the data block is decreased.

One aspect of the present invention is to adapt the gain of the amplifier as early on relative to a received data block, or even before the data block starts. In one preferred embodiment, this early adaptation is achieved by increasing the speed of the control loop, which sets the gain of the amplifier at the start of the time slot associated with the data block. Thus, at the start of the time slot, the adjustment of the gain of the amplifier occurs very quickly to a rough estimation of the proper gain level for the data block corresponding to this time slot. Thereafter, the adjustment of the gain of the amplifier is performed more slowly. Alternatively, the speed at which the gain of the amplifier is adjusted may be controlled depending on an amount of error between a target signal level and a signal level associated with an output of the amplifier. The speed is increased for an increased error and decreased for a decreased error.

In another aspect of the present invention, the gain of the amplifier can be preset with a value associated with the signal level of the data block in preparation for its receipt. The preset value may be determined in conjunction with a previously received time slot from the same source, e.g., the signal power of a corresponding time slot in a prior frame, and may be adjusted if appropriate. The preset value is a prediction of what the gain of the amplifier should be when the data block is received. That prediction may be based on other factors. One aspect of the invention employs a transmitter power sequence, e.g., a ramp-up characteristic of a signal transmitted prior to the data block, to formulate a predicted value. This ramp-up characteristic is typically very consistent for a transmitter corresponding to one time slot in each frame, and once measured and stored, can be scaled to fit power measurements made at the beginning of a data block to predict an appropriate AGC preset value. In one example embodiment, such power measurements are made at the beginning at the beginning of a time block and used to determine a slope of a line associated with those power measurements. Using the power measurements, the slope, and the ramp-up characteristics, the preset value can be determined.

The present invention finds particular application in a cellular radio communication system. In particular, the application can be applied in a radio receiver m a base station and/or in a mobile station. For mobile stations, there is an added benefit in achieving synchronization in certain systems where there are time gaps between the synchronization signals sent by base stations. Predicting an appropriate starting gain level at known points in time for an adjustable amplifier in the mobile station receiver considerably reduces the lag or time delay typically encountered before the gain level is properly set to receive the synchronization signal. For both base and mobile stations, the invention permits rapid adaptation of the AGC loop to handle rapid changes in any received signal as a result of a frame or time slot structure, a signaling structure, or situational/environmental changes like fading, etc.

### BRIEF DESCRIPTION OF THE DRAWINGS

The foregoing and other objects, features, and advantages of the invention will be apparent from the following description of preferred, non-limiting example embodiments, as well as illustrated in the accompanying drawings. The drawings are not to scale, emphasis instead being placed upon illustrating the principles of the invention.

FIG. 1 illustrates how the signal power for different time slots varies between consecutive frames or time slots;

FIG. 2 illustrates a time slot structure in each frame and an example of a mobile station and base station communicating in a time division multiple access mode to using different time slots in the same frame;

FIG. 3 illustrates a non-limiting, example implementation of the present invention in a radio receiver;

FIG. 4 illustrates an example automatic gain controller (AGC) that may be used, for example, in the radio receiver shown in FIG. 3;

FIG. 5 illustrates the inaccuracy and time delay associated with typical reaction of an automatic gain controller to a received signal;

FIG. 6 illustrates example procedures for adjusting an automatic gain control speed in accordance with one aspect of the invention;

FIG. 7 includes signal diagrams that illustrate the AGC speed adjustment outlined in FIG. 6;

FIG. 8 illustrates an AGC speed adjustment procedure in accordance with another aspect of the invention;

FIG. 9 includes signal diagrams which illustrate the procedure outlined in FIG. 8;

FIG. 10 illustrates in flowchart form procedures for an AGC preset routine in accordance with one aspect of the invention;

FIGS. 11 and 12 are signal diagrams illustrating presetting an AGC value information stored from the prior frame;

FIGS. 13 and 14 are signal diagrams illustrating an AGC presetting procedure that has particular application receiving synchronization signals;

FIG. 15 is an AGC presetting routine in accordance with another aspect of the invention;

FIGS. 16A and 16B are signal diagrams that illustrate using a power ramp-up it characteristic to predict an AGC preset value;

FIG. 17 is an AGC preset value prediction routine in accordance with one aspect of the present invention;

FIG. 18 illustrates an example receiving apparatus in which the present invention may be implemented;

FIG. 19 illustrates a time division duplex (ADD) receiver apparatus in which the present invention may be employed; and

FIG. 20 illustrates timer signals applicable to the TDD receiving apparatus shown in FIG. 19.

### DETAILED DESCRIPTION

In the following description, for purposes of explanation and not limitation, specific details are set forth, such as particular embodiments, procedures, techniques, etc., in order to provide a thorough understanding of the present invention. However, it will be apparent to one skilled in the art that the present invention may be practiced in other embodiments that depart from these specific details. For example, the present invention may be implemented in any data communications system between any data transmitter and data receiver that employs an AGC control loop. In some instances, detailed descriptions of well-known methods, interfaces, devices and signaling techniques are omitted so as not to obscure the description of the present invention with unnecessary detail. Moreover, individual function blocks are shown in some of the figures. Those skilled in the art will appreciate that the functions may be implemented using individual hardware circuits, using software functioning in conjunction with a suitably programmed digital microprocessor or general purpose computer, using an Application Specific Integrated Circuit (ASIC), and/or using one or more Digital Signal Processors (DSPs).

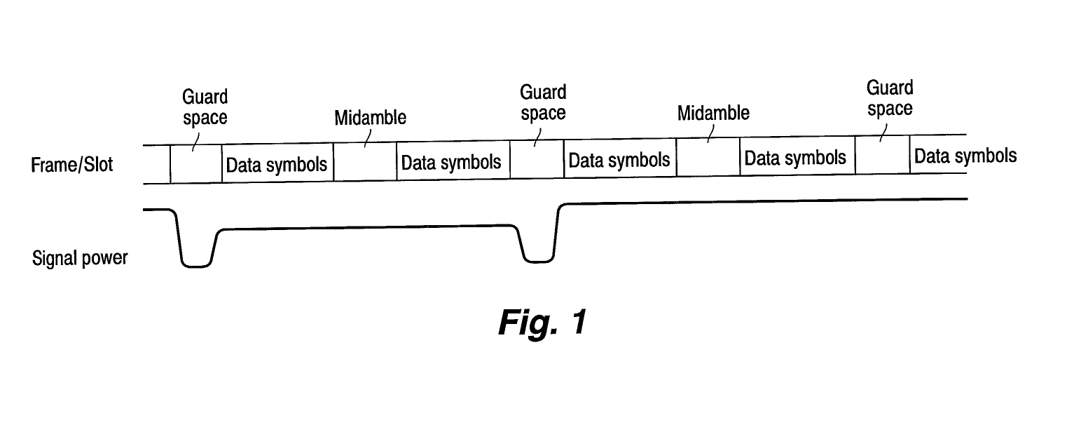

The present invention finds one example application to radio communication systems in which signals received by a radio receiver vary significantly in relatively short periods of time, including but not limited to abrupt signal level changes. For example, in time division duplex AIDD) systems, (like the UTRA/TDD and TD-SCDMA third generation cellular systems), such signal variation is two-fold. First, as can be seen in FIG. 1, there are guard spaces between each frame and time slot. Each frame and time slot contains data symbols, a midamble, followed by further data symbols. During the guard space, the signal power is essentially zero or at the noise floor. The signal level then abruptly changes at the beginning and at the end of the frame and time slot. Moreover, as shown in FIG. 1, the signal power levels often differ frame-by-frame and time slot-by-time slot.

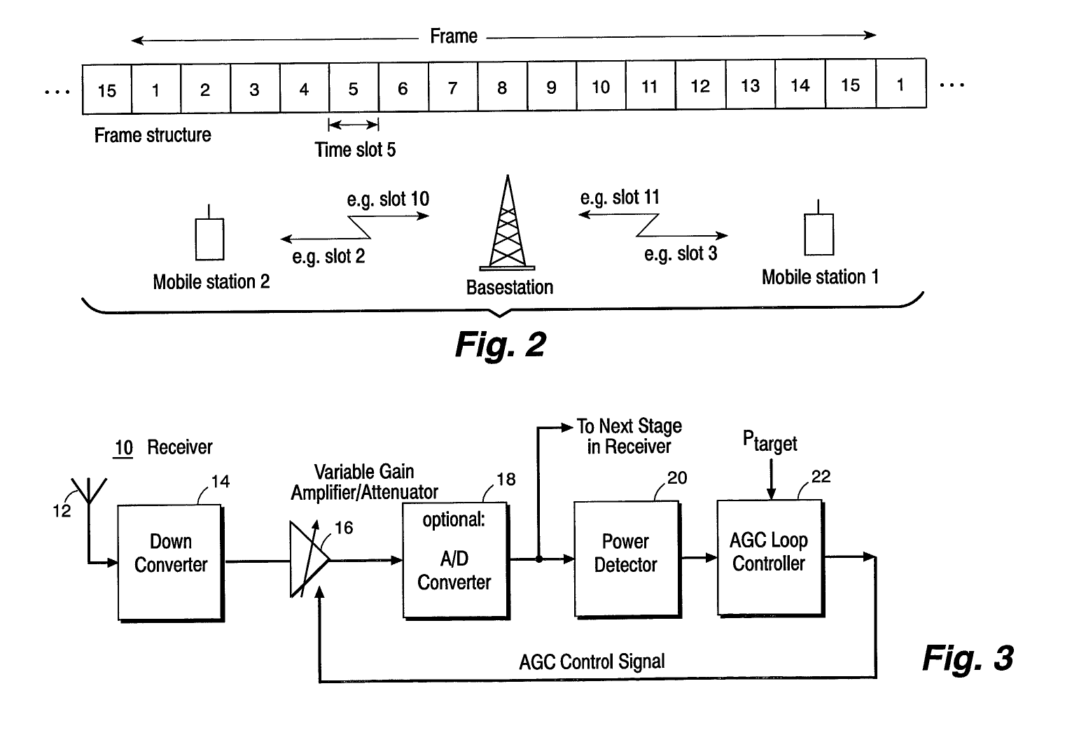

FIG. 2 shows a frame structure where a single frame contains fifteen time slots. Although not shown, there may be guard times between each time slot. Time division multiple access is used in the communications between mobile station 1 and the base station and between the mobile station 2 and the base station. The mobile station 1 communicates with the base station on an uplink channel using time slot 11, while the base station communicates during the same frame on the downlink with the mobile station 1 on time slot 3. Moreover, the base station communicates with the mobile station 2 in the downlink direction on time slot 2, while the mobile station 2 communicates with the base station in the uplink direction on time slot 10 during the same frame.

Because the mobile stations often move, radio paths and radio path obstructions change. These variations mean that the power level of the signal received at the receiver can be quite different for one connection from time slot-to-time slot and from frame-to-frame, particularly at the base station receiver. Nevertheless, there is a substantial correlation in the signal strength during a specific time slot, e.g., time slot 10, in a first frame with that in the same time slot, e.g., 10, in the subsequent frame. As described further below, the present invention utilizes this correlation in favorably adapting the AGC loop in the receiver.

Because of significant and rapid signal level variations between frames and time slots, it is difficult for a variable gain amplifier in the radio receiver to be operating at the proper gain level at the time that a block of data, e.g., a data frame or a time slot, arrives at the receiver. The present invention provides several techniques for rapidly adjusting or presetting the variable gain amplifier in the receiver to an appropriate value for the data block before or as early as possible for each received data block.

One example receiver in which the present invention may be employed is now described in conjunction with a simplified function block diagram of a radio receiver 10 shown in FIG. 3. A radio signal is received at antenna 12 and converted to a lower frequency, e.g., baseband or near baseband, by a down conversion block 14. The details of the down conversion and the actual frequencies are not important for this invention. The down converted signal is input to a variable gain amplifier 16, the gain of which is controlled by an automatic gain control (AGC) control signal. It is to be understood that block 16 can function as an amplifier (a gain greater than one) or an attenuator (a gain less than one). Also, it is to be understood that the gain operation can take place before or after the A/D converter.

The variable gain amplifier 16 adjusts the power level of the received signal in accordance with a dynamic range established for the receiver. For example, the output of the variable gain amplifier may be input to an optional analog-to-digital converter 18 which has a particular dynamic range within which analog signal samples are converted into corresponding digital codes with a desired resolution and without clipping/distortion. The analog-to-digital converter 18, as indicated in FIG. 3, is optional in the non-limiting, example embodiment. The output of the analog-to-digital converter 18 is sent to a next stage in the receiver for further demodulation, decoding, and/or processing. The output of the analog-to-digital is also processed by a power detector 20 which detects the signal level of the received signal output from the variable gain amplifier 16. This power level is input to an AGC loop controller 22 where it is compared with a target signal level (P_{target}) to determine a difference which is used to generate a feed back signal, i.e., the AGC control signal, to adjust the gain of the amplifier 16.

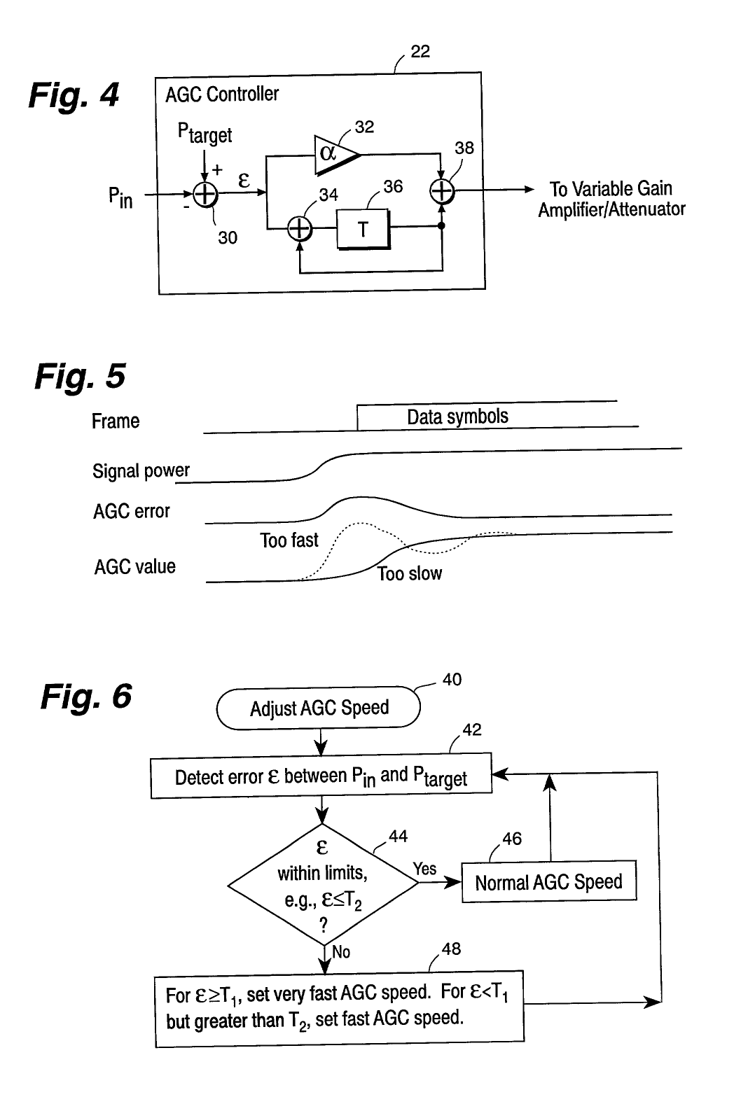

FIG. 4 illustrates an example AGC controller. Elements in the AGC to controller may be implemented in a digital signal processor P)SP) as a preferred implementation of the invention since various values in the AGC controller can be readily changed or preset as required/desired. However, the present invention can also be implemented using discrete hardware circuit components or as one or more application-specific integrated circuits (ASICs). The signal level Pᵢₙ generated by the variable gain amplifier 16 as detected by the power detector 20 is provided to a minus terminal at combiner 30. A target signal level P_{target} is provided at the plus terminal of combiner 30 which outputs a difference or error signal ε provided to a proportional (P) branch and integration branch in a typical PI controller. The proportional path essentially gives an instantaneous correction of the error while the integrating path provides a correction after an accumulation of a portion of all error values. The proportional branch is represented by an amplifier/multiplier 32 which essentially multiplies the error by a particular gain factor α and provides it to a summing node 38. The integration branch (I) sums the current error ε with an accumulated error stored at T and fed back from block 36. The output of summer 34 is now the new value stored in block 36 which is also added to the summer 38 to generate a gain control signal fed back to the variable gain amplifier 16 as the AGC control signal. The output amplifier of the PI control loop is not shown.

FIG. 5 illustrates the problem with traditional AGC control response to a new block of data symbols, for example, in a new frame or time slot having a signal level that abruptly changes from a prior signal level. This is especially the case when the prior signal corresponds to the noise level in a guard space. As the received signal power level Pᵢₙ increases, the AGC error ε increases as well. Eventually, the AGC controller adapts to the changing signal power, and the AGC error is reduced back to zero or to an acceptably small value. As can be seen, there is still an AGC error when there are data symbols to be detected, leading to errors in the data detection. Increasing a, and with that the reaction time of the AGC loop, the error is overcompensated, leading to an unstable oscillatory response as indicated by the dashed line. Another reason to avoid a large a is that the increased AGC speed decreases the reception quality because the fast AGC distorts the received data symbols in rapidly reacting to signal changes. During this overshoot-undershoot oscillation, the output from the variable gain amplifier 16 is not in the desired dynamic range. As a result of the AGC controller not following rapid power level changes, it lags behind, causing the loss of several symbols before the AGC loop is set correctly.

One example embodiment of the present invention rapidly adjusts the speed of the AGC control loop. FIG. 6 illustrates a routine (block 40) for adjusting the AGC loop speed. The error ε between Pᵢₙ and P_{target} is detected (block 42), and a decision is made whether the error ε is within certain tolerable limits (block 44). For example, if the error ε is less than or equal to a threshold T₂, a normal AGC speed is set (block 46), and control returns to block 42. Otherwise, the error is compared with the highest threshold T₁. If it exceeds that higher threshold T₁, the AGC controller is set to a very fast AGC speed (block 48). For errors less than T₁ but greater than T₂, an intermediate fast AGC speed is set. While three different AGC adaptation speeds are disclosed in this routine, this embodiment of the invention may be implemented using only two speeds, fast and normal, or more than three speeds. In addition to regulating the speed of the AGC controller, the speed of power measurements performed by the power detector and/or the sampling time of the AGC loop may also be increased.

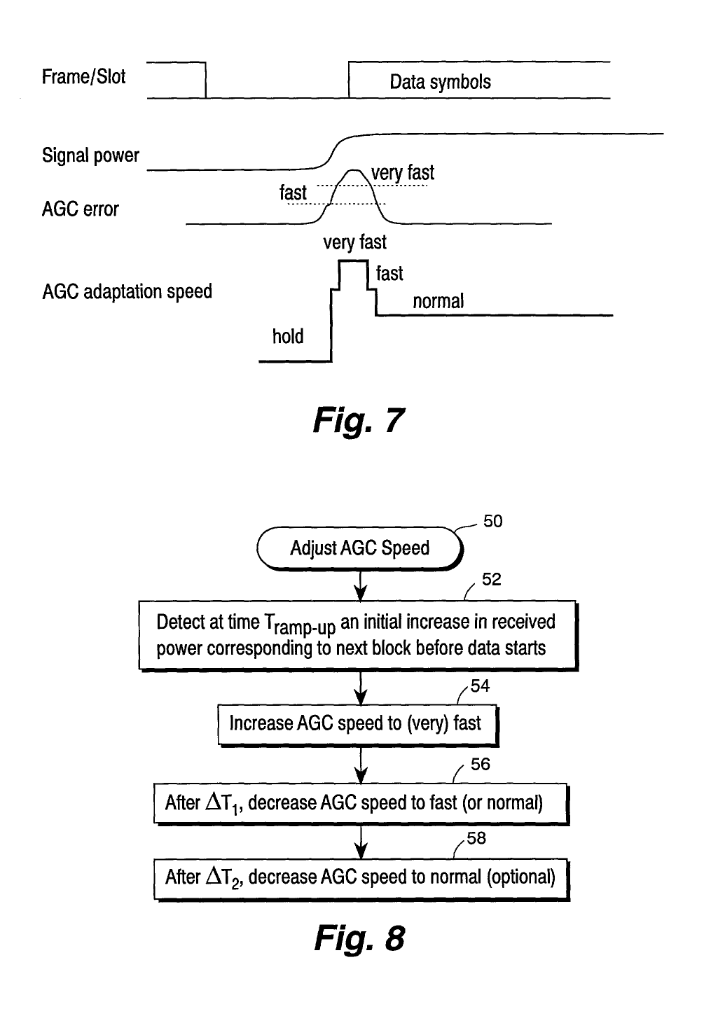

FIG. 7 illustrates another example where the speed of the AGC loop is changed based on the AGC error signal. As the received signal power level increases initially, the AGC adaptation speed goes from a hold position to a fast speed. As the AGC error continues to increase because of the rapidly increasing signal power level, the AGC adaptation speed is again adapted to very fast. Once the AGC error starts to decrease, the AGC adaptation speed is staged back to the fast speed, and subsequently, to a normal speed as the AGC error zeros out, and the signal power level stabilizes.

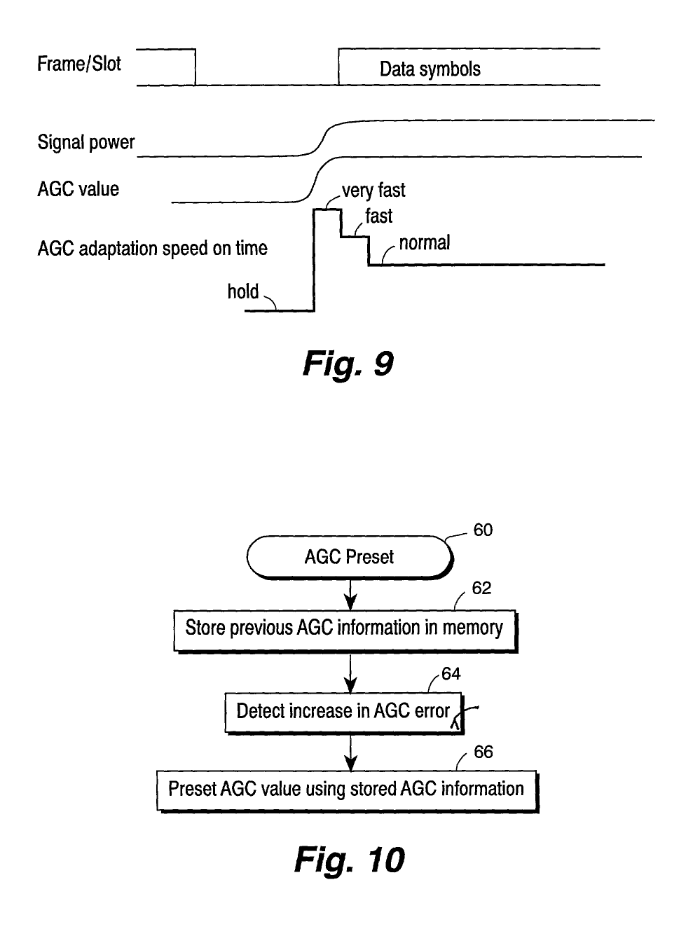

In addition to adjusting the speed of the AGC control loop based upon the AGC error, the AGC control loop speed may be adjusted in a timed sequence making use of the fact that the time that the transmitted signal is received does not vary much from frame-to-frame. Referring to the Adjust AGC Speed routine (block 50) illustrated in flowchart format in FIG. 8, an initial increase in received signal power is detected at time to Tᵣₐₘₚ₋ᵤₚ corresponding to a next data block (block 52). During the ramp-up time before the data starts, the AGC control loop speed is increased to a very fast value (block 54) to rapidly compensate the AGC value. After a certain time period, i.e., Δt₁, the AGC control loop speed is decreased to the next level (fast or normal) (block 56). After a subsequent time period, i.e., Δt₂, the AGC speed is then decreased to normal (optional) (block 58). Again, the number of speed changes can be as little as two or they can be more than the three stages indicated in FIG. 8 and illustrated in FIG. 9.

As shown in FIG. 9, the received signal power increase associated with the next block of data triggers a rapid change of the AGC adaptation speed from a hold value to a very fast value. This causes the AGC control signal to change very rapidly and effectively track the signal power increase. Subsequently, the AGC adaptation speed is decreased back to a normal value where the AGC and signal power level have stabilized. The AGC speed can be increased by increasing the value a, which causes faster compensation of a greater portion of the error in the output signal. The values of the time of course depend upon the particular operation. Example values might be 1/4α for normal, 1.0α for fast, and 4.0α for very fast. In a UTRA/TDD system where typical ramp-up times for radio transmitters on the order of five to ten microseconds, At, and Δt₂ are on the same order of magnitude, i.e., 2.5-5 microseconds, respectively.

Another example embodiment of the present invention solves the problem of rapidly changing signal levels of received signals by presetting the AGC control loop based upon the corresponding time slot information of the previous frame. Consider the AGC Preset Routine (block 60) outlined in flowchart form in FIG. 10 which makes use of 5 AGC settings for previously received data blocks. In block 62, prior AGC information is stored in memory. This value (AGCᵢₙₜ) is re-stored in the integrator of the AGC controller and used as a starting value for the integrator in the new data bock or time slot before the data is received. When the AGC error is detected during the new time slot or at the end of the time slot (block 64), the AGC integrator value is changed to the previously stored AGC value (block 66).

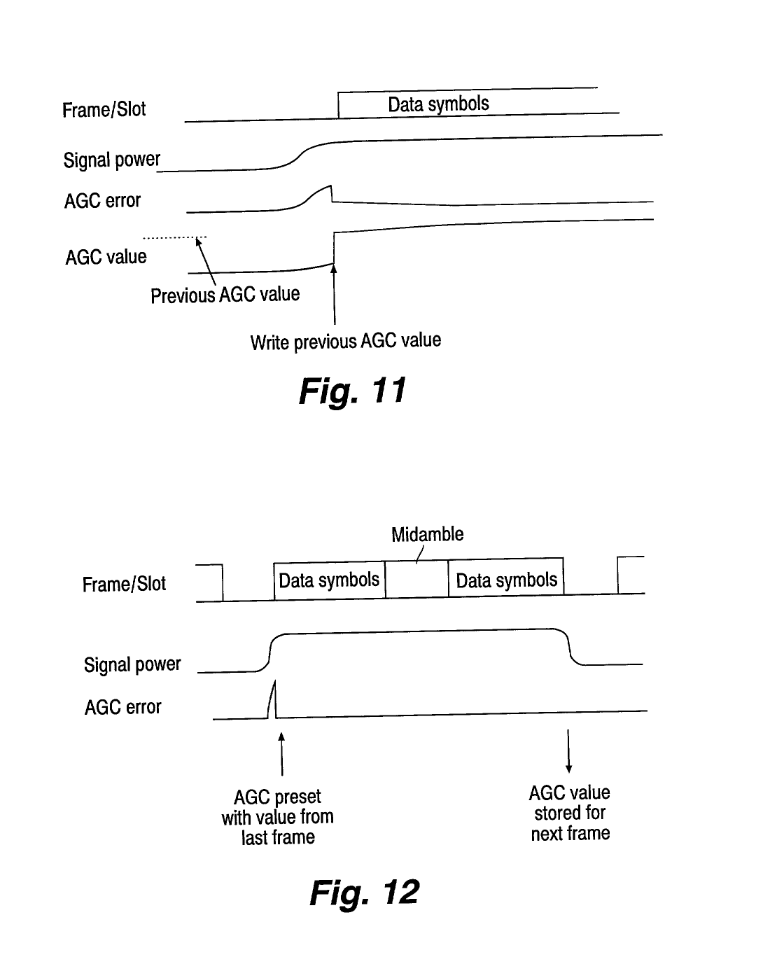

FIGS. 11 and 12 show how the AGC preset approach works in this specific example. At a point in time where there is signal power before the data starts, an AGCᵢₙₜ value previously stored in memory is used in the AGC control loop. This previously stored AGC value is very often close to the final AGC value needed to stabilize at the appropriate signal power level. In this example, the AGC preset value comes from an AGC value stored for a preceding frame and a preceding corresponding time slot. Although the AGC preset value can come from any prior frame or time slot transmitted by the same source, the signal power of the preceding frame or preceding corresponding time slot is often close to what will be the actual signal power of the next frame or corresponding time slot. At the end of the current frame or time slot, the AGC value is then stored for use in presetting the AGC for the next frame or time slot.

Of course, this preset information is to some extent “old information.” During one or more frames, the radio environment can change, e.g., new obstructions may present themselves or disappear, a deep fade occurs, etc. When such rapid changes in situations occur, the AGC preset value may be less accurate, but it is still better than starting from the noise power level. Moreover, the preset value may be corrected or otherwise adjusted to accommodate these kinds of changing situations. For example, the preset AGC value can be corrected for changes in transmit power levels used by one or both of the base station and mobile station.

Presetting of the AGC loop provides quicker and more reliable detection of data at the beginning of a data block and it can be applied to receivers in both base and mobile stations. In particular, in systems like UTRA/TDD and TD-SCDMA where there are discontinuous transmissions of blocks of data, the invention improves reception quality by reducing bit errors in the beginning of the data block.

Presetting of the AGC loop is also important in another example context applicable to mobile stations. When a mobile is initially activated, it searches for a synchronization channel in order to synchronize to the radio access network. In some systems, such as the UTRA/TD system, the synchronization channel is transmitted once or twice per frame in a part of a time slot and has no preamble. Either or both of these factors makes it difficult to adjust the AGC value using typical techniques in order to accurately receive the beginning of the synchronization data or even detect it at all. Another hindrance in this environment is that the mobile radio, when activated, has no prior AGC information from prior receptions to preset the AGC. One solution to this problem is to predict the AGC setting to be preset using information gathered in a previous frame. At start up, the mobile station activates the receiver for a whole time slot and monitors the AGC value. Every time the absolute value of the AGC error crosses a threshold limit, the corresponding time, Tₚᵣₑₛₑₜ, is stored. As soon as the AGC loop stabilizes, the AGC integrator value AGCᵢₙₜ is stored as well. In the next frame at time Tₚᵣₑₛₑₙₜ, the stored AGC value is used in the AGC loop thereby allowing more effective and reliable reception.

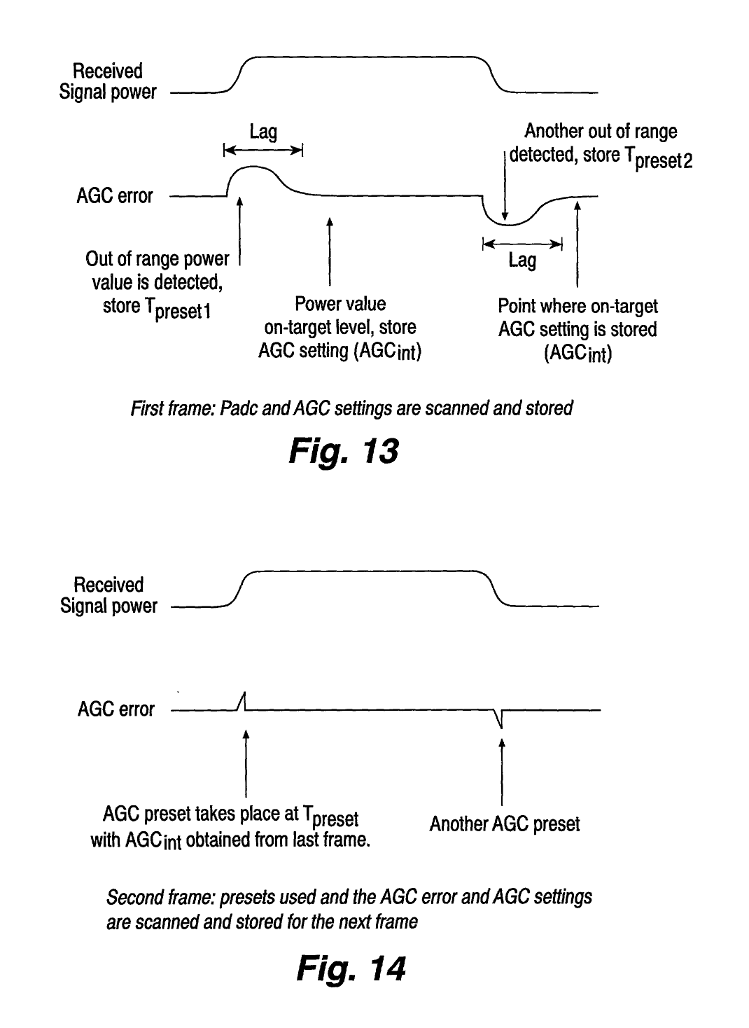

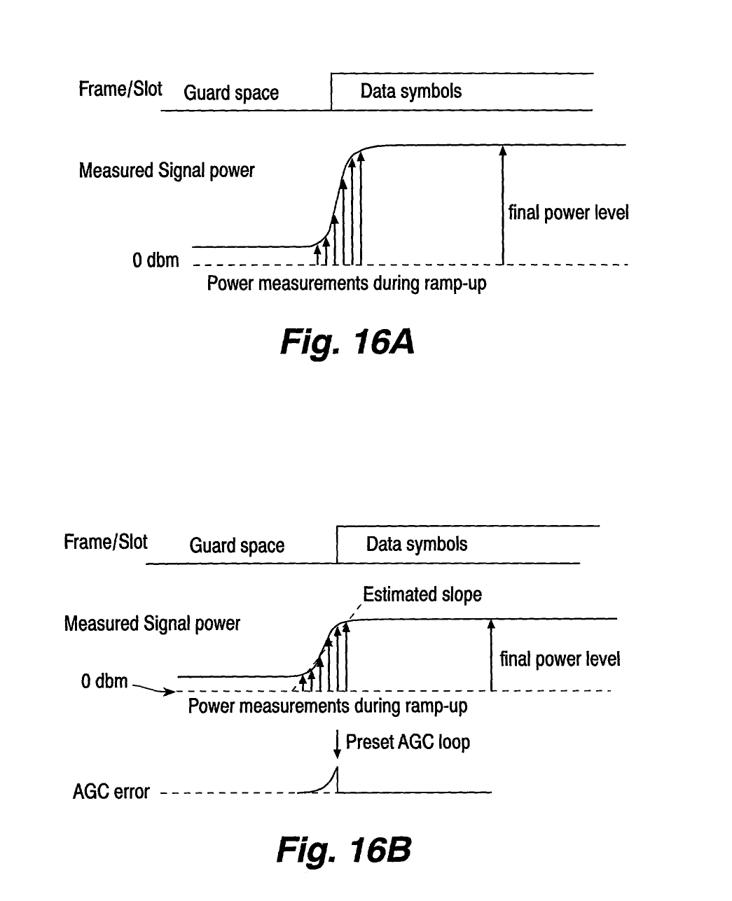

Turning to FIG. 13, a first frame or block of information is received by the mobile radio. As illustrated, the AGC error lags behind both the power increase and the power decrease. In this first frame, when the signal power is detected as being out of range, (i.e., the AGC error is too high), the associated time Tₚᵣₑₛₑₜ is stored in memory. When the signal power stabilizes on target, (i.e., the AGC error is near zero), that AGC integrator setting (AGCᵢₙₜ) is stored in memory associated with the previously stored time Tₚᵣₑₛₑₜ. These time and AGC presettings are performed for both power increases and decreases as shown in FIG. 13. During a next received frame at time Tₚᵣₑₛₑₜ, the AGC controller is preset with the stored AGCᵢₙₜ value from the first frame. This is performed for both power increases and power decreases as illustrated in FIG. 14.

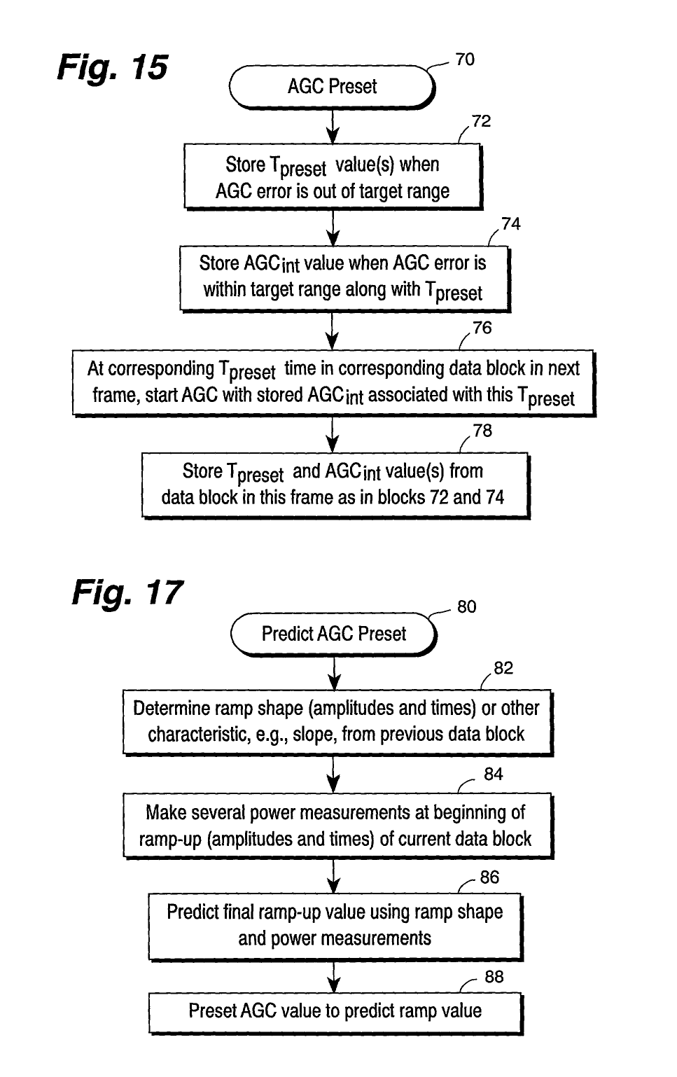

The AGC presetting procedure described in conjunction with FIGS. 13 and 14 is now described in FIG. 15 in the flowchart routine entitled AGC Preset (block 70). One or more Tₚᵣₑₛₑₜ values are stored when the AGC error is out of target range (block 72). The AGC loop controls the gain so that the power level/AGC error is within the target range. The AGC integrator value (AGCᵢₙₜ) at this point contains the correct gain setting for this power level and is stored along with Tₚᵣₑₛₑₜ (block 74). At the corresponding Tₚᵣₑₛₑₜ time in the corresponding data block in the next frame, the AGC loop, e.g., the integrator, is preset with the stored AGCᵢₙₜ associated with this Tₚᵣₑₛₑₜ time (block 76). When the power level/AGC error is initially outside and then within target levels, the appropriate AGC settings, Tₚᵣₑₛₑₜ and AGCᵢₙₜ, respectively, are stored for use in the next frame (block 78). While this aspect of the invention has particular application to mobile stations, it may also be implemented in base stations.

Another example embodiment of the present invention predicts the AGC setting using a ramp-up characteristic of a transmitter power-on sequence. The power ramp-up characteristic refers to the manner in which the transmitter increases its transmit power level at the start of a time slot or other data block. Preferably, the power ramp-up is not performed too quickly, e.g., in one step, because this results in undesirable spurious frequencies that interfere with other frequency bands. In UTRA/IDD, for example, the allowed spurious ramp-up and the maximum ramp-up are predefined in the UTRA/TDD standard. If the transmitter ramp-up is constrained and relatively consistent, this information can be used to predict an AGC preset value.

An example of a power ramp-up at the start of a data block is shown in FIG. 16A. FIG. 16A shows the measured signal power of a received signal at the receiver which essentially corresponds in its shape to the received signal strength at the receiver. Upon receiving the data block, several power measurements are made before the actual start of the data block, i.e., during the ramp-up period. These power measurements provide an indication of the shape, (e.g., amplitude, slope, timing, etc.), of the ramp-up. This ramp-up shape information is stored and may be used in a next time slot in a next frame to predict an appropriate AGC presetting for that next data block.

A practical difficulty with this approach is that power measurement typically involves an integration stage to reduce noise levels. As a result, the ramp-up power measurements may lag behind the actual signal. The present invention overcomes this inherent delay in order to achieve an appropriate predicted AGC presetting as will now be described in conjunction with FIG. 16B. Comparing the ramp-up waveforms of FIGS. 16A and 16B, it can be seen that when originating from one transmitting source, the shapes of the power ramp-up curves are essentially the same except that the final power level amplitude is different. Once the ramp-up shape of one transmitting source is known, measurements are made of the ramp-up amplitudes during the first half of the ramp-up (before the actual data block begins). From these initial ramp-up amplitude measurements and the known shape, a final power level value may be predicted and used as a preset value for the AGC loop.

This prediction based on “curve fitting” may be accomplished in various ways. One way is to formulate a line through the actual measured data and use that line (its slope and starting points) to extrapolate a final power level value. Other approaches include comparing individual sizes and averaging, cross-correlating between the two sets of data, and known curve fitting techniques. FIG. 16B illustrates an example where the slope is determined for a straight line estimated from the ramp-up curve. After the first samples are obtained in the measured signal power in FIG. 16B, the slope of the curve is estimated using a tangent line of the linear part of the ramp-up curve. From the tangent line and slope, the final power level is calculated and stored. This final value is then used as the preset value to the AGC control loop as shown at the bottom of FIG. 16B.

One more specific procedure might include the following steps. For the reference ramp-up curve, the final power and slope are known:

Power1=slope1*t+offset, where t is time.

For the new curve, the slope is detected for the linear part of the curve, and the same equation is employed:

Power2=slope2*t+offset.

Subtracting the two formulas gives:

(Power1−Power2)=(slope1−slope2)*t.

Therefore, the slope difference corresponds to a difference in final power level. The AGC integrator value may have a direct relation with the power value and can be calculated from the slope difference.

The general procedures for predicting the preset AGC value are now set forth in flowchart form in the procedure shown in FIG. 17 entitled the Predict AGC Preset (block 80). The power-up ramp shape or other characteristic, e.g., slope, is determined from a previous data block (block 82). Several power measurements are made to determine the slope of the ramp-up curve of the current data block (block 84). A final power value is calculated using the slope or ramp-up shape from the prior data block and the current power measurements (block 86). The preset value of the integrator of the AGC is then calculated using the final power value (block 88).

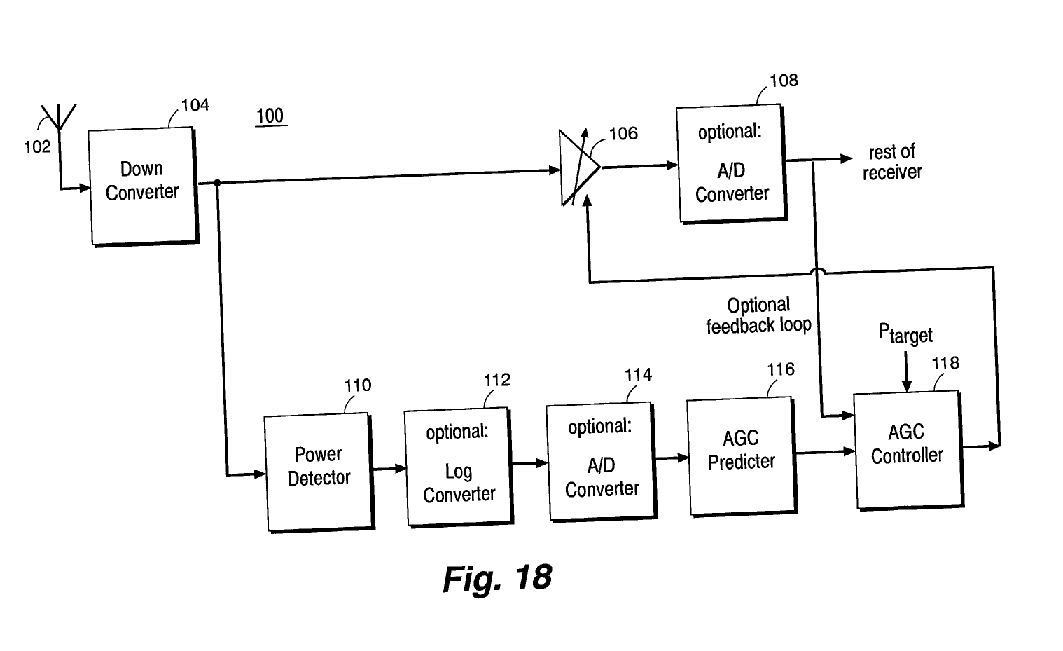

While the present invention may be employed using a variety of AGC implementations, including that shown in FIG. 3, another example implementation is shown in the simplified receiver 100 of FIG. 18. An antenna 102 receives an RF signal which is downconverted in frequency in downconversion block 104. The output of the downconversion block is provided to the variable gain amplifier 106 as well as to a power detector 110 where the power level of the received signal is measured and preferably averaged. The detected power is provided to an optional logarithmic converter 112 to allow for a larger signal range for an analog-to-digital converter having a limited dynamic range. The analog signal from the log converter 112 is converted into digital format by analog-to-digital converter 114 (also optional). The digital output is provided to an AGC predictor 116 which provides a preset AGC value provided to the AGC controller 118 before or at the beginning of a data block. The AGC controller 118 also receives the output from the variable gain amplifier 106, which optionally may have been converted to digital format in analog-to-digital converter 108 which, coupled with the power target value, is used to generate an AGC control signal fed back to adjust the gain of the amplifier 106.

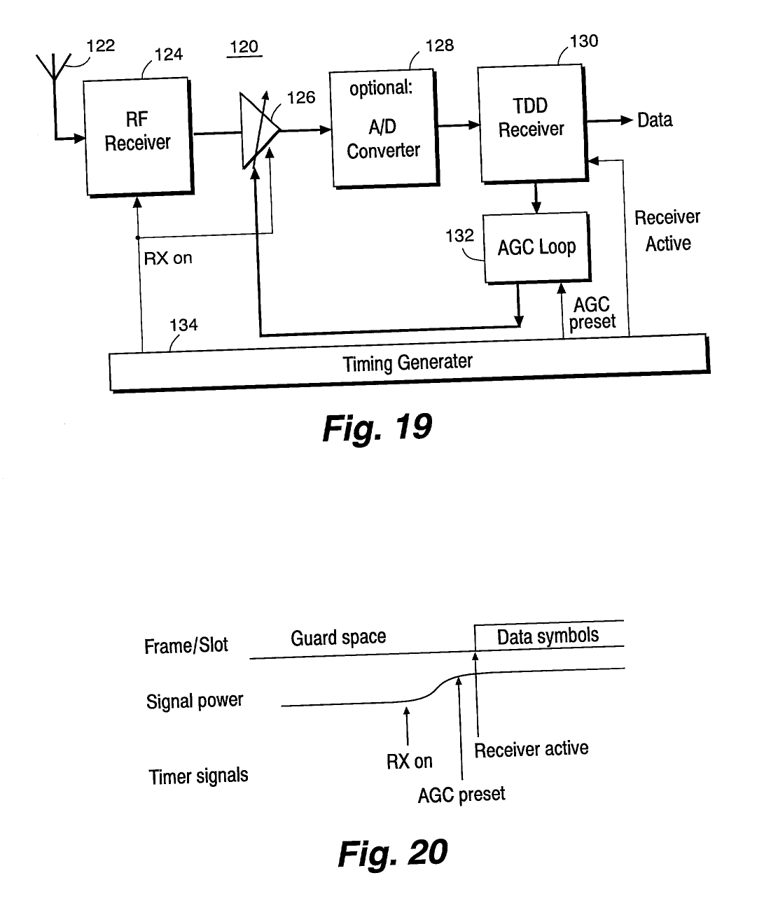

Another example implementation is shown in the context of a simplified TDD receiver 120 in FIG. 19. The RF signal is received via antenna 122 and downconverted in RF receiver section 124. The output of the RF receiver is provided to the adjustable gain amplifier 126, the output of which may be digitized in optional analog-to-digital converter 128. The digitized output is provided to TDD receive processing block 130 which further demodulates and decodes the digital information. A simplified AGC loop is indicated at block 132 for generating an AGC control signal to vary the gain of amplifier 126. A timing generator 134 is used to switch on the RF receiver 124 and adjust variable gain amplifier 126 some time period, e.g., corresponding to the transmit ramp-up time, before the actual data block appears. When the signal power has almost reached its maximum, a possible AGC preset might occur to set the AGC loop at a desired value. This latter procedure is illustrated in FIG. 20.

While the present invention has been described with respect to particular example embodiments, those skilled in the art will recognize that the present invention is not limited to those specific embodiments described and illustrated herein. Different formats, embodiments, adaptations besides those shown and described, as well as many modifications, variations and equivalent arrangements may also be used to implement the invention. Although the present invention is described in relation to preferred example embodiments, it is to be understood that this disclosure is only illustrative and exemplary of the present invention. The scope of the invention is defined by the appended claims.

What is claimed:

1. A method for use in a receiver including an amplifier with an adjustable gain, comprising:
receiving data blocks, each data block potentially having a different signal level, and
adjusting the gain of the amplifier for a received signal level of one data block before data in the one data block are amplified in the amplifier.

2. The method in claim 1, wherein the one data block is associated with a corresponding time period.

3. The method in claim 2, further comprising:
increasing a speed at which the gain of the amplifier is adjusted before or at a beginning of the time period.

4. The method in claim 3, wherein the speed is increased depending on a time relative to the time period.

5. The method in claim 3, wherein the speed increases in stages starting before or at the beginning of the time period.

6. The method in claim 5, wherein the stages include a first stage having a faster speed than a second subsequent stage.

7. The method in claim 3, wherein the speed is adjusted depending on an amount of error between a target signal level and a signal level associated with an output of the amplifier.

8. The method in claim 7, wherein the speed is increased for an increased error and decreased for a decreased error.

9. The method in claim 8, wherein the speed is increased or decreased in stages.

10. The method in claim 7, wherein the speed is not adjusted unless a magnitude of the error exceeds a threshold.

11. The method in claim 7, further comprising:
increasing a speed at which the signal level associated with an output of the amplifier is measured prior to the beginning of the time period.

12. The method in claim 2, wherein the adjusting includes presetting a gain of the amplifier with a preset value associated with the signal level of the one data block in preparation for receiving the one data block.

13. The method in claim 12, wherein the preset value is associated with a previously received time period.

14. The method in claim 13, wherein the preset value is a signal power of the previously received time period.

15. The method in claim 13, wherein the previously received time period corresponds to a time slot in a frame of time slots received before the frame of time slots having a same frame position as the one time slot.

16. The method in claim 12, further comprising:
adjusting the preset value.

17. The method in claim 16, wherein the preset value is adjusted for a transmit power level change.

18. The method in claim 12, further comprising:
storing the gain of the amplifier for the one data block, and
using the stored gain to preset the gain for a subsequent data block.

19. The method in claim 12, further comprising:
predicting the preset value based on a transmitter power sequence, and
presetting the gain for the amplifier for the one block using the predicted preset value.

20. The method in claim 19, further comprising:
determining a ramp-up characteristic of a signal transmitted prior to the one data block, and
using the ramp-up characteristic to predict the preset value.

21. The method in claim 20, wherein the using includes:
making several power measurements at a beginning of the one time block, and
correlating the several power measurements with the ramp-up characteristic to predict the preset value.

22. The method in claim 20, wherein the using includes:
making several power measurements at a beginning of the one time block;
determining a slope of line associated with the power measurements; and
using the power measurements, the slope, and the ramp-up characteristic to predict the preset value.

23. The method in claim 1, wherein the gain adjustment is an automatic gain control (AGC) signal.

25. Apparatus for use in a radio receiver, comprising:
receiving circuitry for receiving a radio signal including multiple data blocks, each data block potentially having a different signal level, and
an adjustable gain amplifier for adjusting a signal level of received data blocks; and
a gain controller for adjusting the gain of the amplifier for a received signal level of one data block before the data in one data block are amplified in the amplifier.

26. The apparatus in claim 25, wherein the one data block is associated with a corresponding time slot.

27. The apparatus in claim 26, wherein the radio receiver is a time division duplex ADD) receiver including a TDD timing generator for coordinating time division duplexed communications, and wherein each data block is separated from adjacent data blocks by a guard space.

28. The apparatus in claim 25, wherein the gain controller includes:
a differencer for determining a difference between a target signal level and a signal level associated with an output of the amplifier to produce an error, and
processing circuitry for processing the error and generating a control signal used to adjust the gain of the amplifier based on the error.

29. The apparatus in claim 28, wherein the processing circuitry includes:
a multiplier for multiplying the error by a gain term;
an integrator for integrating the error over a time period; and
a summer for summing an output from the multiplier and the integrator, the output of the summer corresponding to the control signal.

30. The apparatus in claim 29, wherein the integrator includes a store for storing a preset gain value prior to receiving the one data block and for using the stored gain value in generating the integrator output.

31. The apparatus in claim 25, wherein the one data block is associated with a corresponding time period.

32. The apparatus in claim 31, wherein the gain controller is configured to increase a speed at which the gain of the amplifier is adjusted at a beginning of the time period.

33. The apparatus in claim 32, wherein the gain controller is configured to increase the speed depending on a time relative to the time period.

34. The apparatus in claim 32, wherein the gain controller is configured to increase the speed in stages starting at or before the beginning of the time period.

35. The apparatus in claim 34, wherein the stages include a first stage having a faster speed than a second subsequent stage.

36. The apparatus in claim 31, wherein the gain controller is configured to determine an amount of error between a target signal level and signal level associated with an output of the amplifier and to increase the speed depending on the amount of error.

37. The apparatus in claim 31, wherein the gain controller is configured to increase the speed for an increased error and decrease the speed for a decreased error.

38. The apparatus in claim 37, wherein the gain controller is configured to increase or decrease the speed in stages.

39. The apparatus in claim 37, wherein the gain controller is configured to not adjust the speed unless a magnitude of the error exceeds a threshold.

40. The apparatus in claim 37, further comprising:
a signal strength detector for measuring a signal level associated with an output of the amplifier prior to the beginning of the time period,
wherein the gain controller is configured to increase a speed at which the signal strength detector measures the signal level associated with an output of the amplifier.

41. The apparatus in claim 25, wherein the gain controller is configured to preset a gain of the amplifier with a preset value associated with the signal level of the one data block in preparation for receiving the one data block.

42. The apparatus in claim 41, wherein the preset value is associated with a previously received time period.

43. The apparatus in claim 42, wherein the preset value is a signal power of the previously received time period.

44. The apparatus in claim 43, wherein the previously received time period corresponds to a time slot in a frame of time slots received before the frame of time slots having a same frame position as the one time slot.

45. The apparatus in claim 41, wherein the gain controller is configured to adjust the preset value.

46. The apparatus in claim 45, wherein the gain controller is configured to adjust the preset value for a transmit power level change.

47. The apparatus in claim 41, wherein the gain controller includes a store for storing the gain of the amplifier for the one data block, and wherein the gain controller is configured to use the stored gain to preset the gain for a subsequent data block.

48. The apparatus in claim 41, wherein the gain controller includes a predictor for predicting the preset value based on a transmitter power sequence, and
wherein the gain controller is configured to preset the gain for the amplifier for the one block using the predicted preset value.

49. The apparatus in claim 42, wherein the predictor is configured to determine a ramp-up characteristic of a signal transmitted prior to the one block and to use the ramp-up characteristic to predict the preset value.

50. The apparatus in claim 42, wherein the predictor is configured to make power measurements at a beginning of the one time block and to correlate the power measurements with the ramp-up characteristic to predict the preset value.

51. The apparatus in claim 42, wherein the predictor is configured to make several power measurements at a beginning of the one time block, to determine a slope of line associated with the power measurements, and to use the power measurements, the slope, and the ramp-up characteristic to predict the preset value.

52. The apparatus in claim 25, wherein the gain controller is an automatic gain controller.

53. The apparatus in claim 52, further comprising:
an analog to digital converter,
wherein the amplifier output is coupled to an analog to digital converter and an output of the analog to digital converter is coupled to the automatic gain controller.
